(19) United States
(12) Patent Application Publication
(10) Pub. No.: US 2023/0214756 A1
(43) Pub. Date: Jul. 6, 2023

(54) Vehicle fleet management system

(71) Applicant: OmniEyes Co., Ltd. Taiwan Branch, Taipei (TW)

(72) Inventors: Chun-Ting CHOU, Taipei (TW); Chiao-Yi WEN, Taipei (TW); Ruei-Kai CHENG, Taipei (TW); Yi-Yen WANG, Taipei (TW); Chia-Chin HO, Taipei (TW); Ming-Shan GAO, Taipei (TW); Ren-Jie PAN, Taipei (TW); Chung-Sheng LAI, Taipei (TW); Chih-En HUANG, Taipei (TW)

(21) Appl. No.: 17/565,987

(22) Filed: Dec. 30, 2021

(51) Int. Cl. G06Q 10/06

(52) U.S. Cl. CPC G06Q 10/06398

(57) ABSTRACT

A fleet vehicle management system includes an edge device disposed in a vehicle and a cloud device. A processing module of the edge device acquires around-view image and determines at least one traffic indication accordingly. The nearing event warning module of the edge device sends out a nearing event alert to a driver via an output module. The after event detection module of the edge device acquires GPS informations in a first time interval and a second time interval respectively to determine whether the vehicle meets an after event criterion. A violation event is triggered if the after event criterion is met. A database of the cloud device stores the nearing event alert, a driving violation result and a driving record information. The driver behavior analysis module generates an information for evaluating a driving score based on the nearing event, the violation event and the driving record information.

### FIELD OF THE INVENTION

The invention relates to a fleet vehicle management system, more particularly to a fleet vehicle management system capable of detecting and alerting dangerous driving in advance and effectively evaluating a driver's driving behaviors.

### BACKGROUND OF THE INVENTION

Fleet vehicle management is increasingly developed to promote efficiency and safety of vehicles such as cars or trucks driving on the road or land vehicles (such as forklift trucks or pallet trucks) driving in a specific field. Most of the systems and methods focus on using positioning to manage the vehicle's driving route and analyzing the acquired images, so as to manage the vehicle and/or driver.

The fleet vehicle management systems and methods are disclosed in, for example, Chinese Patent Publication No. CN112802344A, U.S. Pat. No. 10,643,477B2, U.S. Patent Publication No. US20140114502A1, U.S. Pat. No. 10,671,869B2, U.S. Pat. No. 10,719,725B2, etc.

However, the prior art failed to detect or determine dangerous driving behaviors or moving violations, thus increasing the risk of car accidents and violation. For a fleet manager, in order to improve operational efficiency, a video recorded by a dashboard camera on each vehicle must be constantly monitored manually so as to make assessment accordingly, which will take a lot of manpower and be costly, and it will be extremely difficult to implement. Therefore, there is room for improvement in the existing fleet vehicle management solutions.

### BRIEF DESCRIPTION OF THE DRAWINGS

FIG. 1 illustrates a block diagram according to one embodiment of the invention.

FIG. 2 is a flowchart showing various steps of a method according to one embodiment of the invention.

FIG. 3 illustrates a block diagram according to one embodiment of the invention.

FIG. 4 through FIG. 12 illustrate various examples of the nearing events and violation events according to different examples of the invention.

### SUMMARY OF THE INVENTION

A main object of the invention is to solve the problem that the conventional vehicle fleet management system cannot effectively detect or determine dangerous driving behaviors or moving violations, thus causing difficulty in risk management and control.

In order to achieve the above object, the invention provides a fleet vehicle management system, comprising an edge device disposed in a vehicle, and the edge device comprising a processing module, a nearing event warning module, an after event detection module, an image capturing module, a GPS module and a moving status module, the processing module is configured to acquire at least one around-view image and determine at least one target according to the around-view image; and a cloud device communicatively connected to the edge device, the cloud device comprising a driver behavior analysis module and a database; wherein the nearing event warning module acquires a nearing event criterion according to the at least one target, the nearing event warning module acquires at least one moving status information of the vehicle in a first time interval from the moving status module, and acquires at least one GPS information of the vehicle in the first time interval from the GPS module to determine whether the vehicle meets the nearing event criterion, a nearing event is triggered when the nearing event criterion is met, the nearing event warning module sends out a nearing event alert to a driver of the vehicle via an output module disposed in the vehicle; wherein the after event detection module acquires an after event criterion according to the at least one target, the after event detection module acquires the at least one moving status information of the vehicle in the first time interval and the at least one moving status information of the vehicle in a second time interval from the moving status module, and acquires the at least one GPS information of the vehicle in the first time interval and at least one GPS information of the vehicle in the second time interval from the GPS module to determine whether the vehicle meets the after event criterion, and a violation event is triggered when the after event criterion is met; and wherein the database is configured to store the nearing event alert, a driving violation result and a driving record information of the driver, and the driver behavior analysis module generates an information for evaluating a driving score of the driver based on the nearing event, the violation event and the driving record information.

The invention further provides a fleet vehicle management system, comprising an edge device disposed in a vehicle, and the edge device comprising a processing module, a nearing event warning module, an after event detection module, an image capturing module, a GPS module and a moving status module, the processing module being configured to acquire at least one around-view image and determine at least one target according to the around-view image; and a cloud device communicatively connected to the edge device, the cloud device comprising a driver behavior analysis module and a database; wherein the nearing event warning module acquires a nearing event criterion according to the at least one target, the nearing event warning module acquires at least one moving status information of the vehicle in a first time interval from the moving status module, and acquires at least one GPS information of the vehicle in the first time interval from the GPS module to determine whether the vehicle is moving on a route that may collide with the at least one target to confirm whether the vehicle meets the nearing event criterion, and a nearing event is triggered when the nearing event criterion is met, the nearing event warning module sends out a nearing event alert to a driver of the vehicle via an output module disposed in the vehicle; wherein the after event detection module acquires an after event criterion according to the at least one target, the after event detection module acquires the at least one moving status information of the vehicle in the first time interval and the at least one moving status information of the vehicle in a second time interval from the moving status module, and acquires the at least one GPS information of the vehicle in the first time interval and at least one GPS information of the vehicle in the second time interval from the GPS module to determine whether the vehicle meets the after event criterion, and a violation event is triggered when the after event criterion is met; and wherein the database is configured to store the nearing event alert, a driving violation result and a driving record information, of the driver, and the driver behavior analysis module generates an information for evaluating a driving score of the driver based on the nearing event, the violation event and the driving record information.

### DETAILED DESCRIPTION OF THE PREFERRED EMBODIMENTS

Herein, although some embodiments perform steps in a particular order, the steps may be performed in another order other than that specifically disclosed, or multiple steps may be combined in a single step. Technical features described below may be replaced or eliminated for different embodiments. It should be understood that additional operations may be performed before, during, or after the recited method, and that operations may be replaced or omitted in other embodiments of the method.

The terminology used herein is only for a purpose of describing specific embodiments and does not intend to limit the invention. Unless the context indicates otherwise, the singular forms “a”, “an” and “the” used herein may also include plural forms.

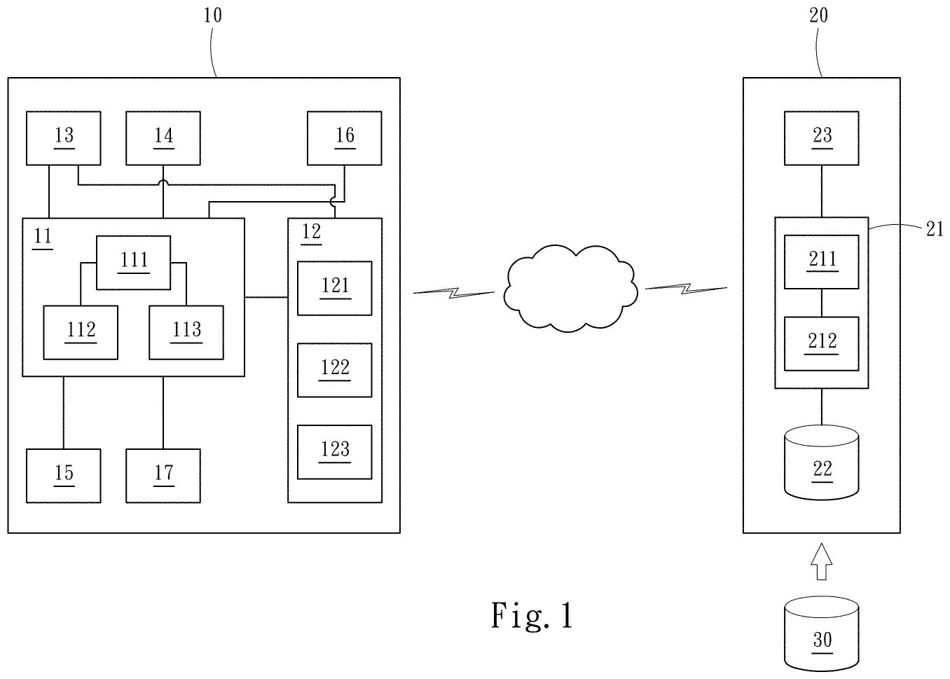

The invention discloses a fleet vehicle management system. Referring to FIG. 1, in one embodiment, the system comprises an edge device 10, a cloud device 20 and an external data source 30. The edge device 10 is an in-vehicle device installed in a vehicle, the edge device 10 comprises a processing unit 11, a moving status module 12, an image capturing module 13, a GPS module 14, an output module 15, a first wireless communication module 16 and a memory unit 17. In one embodiment, the processing unit 11 can be implemented by a processor, the processing unit 11 may comprise a processing module 111, a nearing event warning module 112 and an after event detection module 113. The moving status module 12 can be implemented by one or more sensors, including a gyroscope 121, an accelerometer 122 and an ignition status monitor module 123.

The cloud device 20 may be implemented by a server or a computer. The cloud device 20 comprises a processing unit 21, a database 22 and a second wireless communication module 23. The processing unit 21 can be implemented by a processor, the processing unit 21 comprises a driver behavior analysis module 211 and a driver score analysis module 212. A wireless communication connection can thus be established between the first wireless communication module 16 and the second wireless communication module 23 through Internet connection.

In the invention, an event refers to collision, accident, incident or violation of traffic laws, traffic regulations or traffic signs caused by the vehicle. The nearing event warning module 112 and the after event detection module 113 respectively acquire a plurality of information related to the vehicle during driving or stop from a plurality of modules, and determine whether a specific condition is met by using the plurality of information as parameters. The nearing event warning module 112 detects that the vehicle may be about to cause the event (i.e., at a time point before the event occurs). In other words, a determination of the nearing event warning module 112 is designed to be triggered when the vehicle is very likely to cause the event according a moving status of the vehicle at that time point, that is, the event has not occurred but may constitute danger or risk; the after event detection module 113 detects that the vehicle has caused the event (i.e., after the event has occurred). In other words, a determination of the after event detection module 113 is designed to be triggered when the vehicle has caused the event according the moving status of the vehicle at that time point, that is, the event has occurred.

It can be understood that the nearing event warning module 112 and the after event detection module 113 perform detection according to the information at different times. The nearing event warning module 112 collects the plurality of information of the vehicle in a first time interval, and the after event detection module 113 respectively collects a information of the vehicle in the first time interval and the information of the vehicle in a second time interval. In some embodiments, the second time interval is followed after the first time interval and, such as the time before and the time after the vehicle passes through a single intersection. For example, if the first time interval is 5 seconds before the vehicle passes through an intersection, the second time interval would be 5 seconds after the vehicle has passed through the intersection. The nearing event warning module 112 determines whether a nearing event criterion is met when the vehicle is approaching the intersection according to the information acquired in the first time interval; the after event detection module 113 determines whether an after event criterion is met in a time interval of 5 seconds after the vehicle has passed through the intersection according to the information acquired in the first time interval and the second time interval; the information can also be understood as the information at the time during the first time interval through the second time interval (from 5 seconds before passing the intersection to 5 seconds after passing the intersection).

For example, the after event detection module 113 acquires at least one around-view image during the first time interval to identify at least one traffic indication or at least one target and also acquires at least one moving status and at least one GPS information of the vehicle during the first time interval and at least one moving status and at least one GPS information of the vehicle during the second time interval (or from the first time interval to the second time interval) to know the vehicle's condition when passing (or before and/or after) the traffic indication or the at least one target, to determine whether the after event criterion is met.

The moving status module 12 is configured to acquire at least one moving status information of the vehicle constantly or intermittently. For example, the at least one moving status information comprises a triaxial angular velocity of the vehicle acquired from the gyroscope 121, a triaxial acceleration of the vehicle acquired from the accelerometer 122, turn-on or turn-off of an engine of the vehicle which is detected by the ignition status monitor module 123, etc. In one example, the at least one moving status module 12 is coupled to the image capturing module 13, the moving status information further comprises one or more images around the vehicle acquired from the image capturing module 13. The GPS module 14 is configured to acquire at least one GPS information of the vehicle, for example, the at least one GPS information can be a position of the vehicle, a moving direction of the vehicle, and a speed of the vehicle.

The image capturing module 13 can be implemented by one or more video cameras. The image capturing module 13 acquires one or more images around the vehicle. In one example, the around-view image is a forward (front facing) image of the vehicle. In other examples, the around-view image can also be (or can further comprise) a backward (rear facing) image, a side facing image and/or a bird's-eye-view image. The image capturing module 13 transmits the around-view image to the processing unit 11, and the processing module 111 is capable of determining or identifying either at least one traffic indication or at least one target from the around-view image using data mining. The traffic indication is at least any one of a traffic sign, a traffic light, a ground sign or a ground marking, and the at least one target is at least any one of a pedestrian, an animal, a land vehicle (such as a motorbike, a bicycle, a car, a truck, a bus, etc.), a moving obstacle or a fixed obstacle.

The output module 15 can be implemented by a loudspeaker, a display screen or a steering wheel, and the output module 15 is configured to send out a nearing event alert to a driver of the vehicle. The nearing event alert can be a visual alert, a sound alert, a haptic alert or any combination thereof.

The memory unit 17 stores a data in advance, the data can comprise a plurality of traffic indication information, a plurality of target information, a plurality of nearing event criterions corresponding to the traffic indication information and the plurality of target information respectively, and a plurality of after event criterions corresponding to the traffic indication information and the plurality of target information respectively. In one example, the data can be presented by rules, e.g., the data is configured for the processing unit 11 of the edge device 10 to perform a rule-based classification on the around-view image for identify the traffic indication, the target, determinations of the plurality of nearing event criterions and the plurality of after event criterions. It can be understood that a single traffic indication information (or target information) may be associated to one or more of the nearing event criterions/the after event criterions. For example, when the traffic indication information is that a speed limit of the vehicle is not allowed to exceed 50 km/h, then at least one nearing event criterion is that a speed of the vehicle is between 40 km/h and 50 km/h and an acceleration of the vehicle is between 1 m/s² and 2 m/s², at least one after event criterion is that a speed limit of the vehicle is greater than 50 km/h. When at least one target information is a pedestrian, then the at least one nearing event criterion comprises that the pedestrian is located within a range of 15 degrees left and right of the vehicle's expected moving direction, a distance between the vehicle and the pedestrian is less than 20 meters, a speed of the vehicle is greater than 40 km/h and an acceleration of the vehicle is greater than −5 m/s².

During operation, the image capturing module 13 acquires the around-view image, the moving status module 12 acquires the at least one moving status information of the vehicle, and the GPS module 14 acquires the at least one GPS information of the vehicle. When the traffic indication is detected around the vehicle as determined from the around-view image, the nearing event warning module 112 acquires the at least one nearing event criterion based on the traffic indication, and the nearing event warning module 112 determines whether the at least one moving status information and the at least one GPS information of the vehicle meet the at least one nearing event criterion. When the at least one nearing event criterion is satisfied (e.g., according to the at least one moving status information and the at least one GPS information of the vehicle in the first time interval), the nearing event warning module 112 determines that a nearing event occurs, and sends out the nearing event alert via the output module 15 which is installed in the vehicle.

On the other hand, when the at least one target is detected around the vehicle as determined from around-view image, the nearing event warning module 112 acquires the at least one nearing event criterion based on the target. Then, the nearing event warning module 112 determines whether the vehicle is moving on a route that may collide with the at least one target based on the at least one target in the around-view image, the at least one moving status information and the at least one GPS information of the vehicle, if so, the nearing event warning module 112 further determines whether the at least one moving status information and the at least one GPS information of the vehicle in the first time interval meet the at least one nearing event criterion. When the at least one nearing event criterion is met, the nearing event warning module 112 sends out the nearing event alert via the output module 15 which is installed in the vehicle. In some embodiments, in addition to the at least one moving status information and the at least one GPS information of the first time interval, the nearing event warning module 112 further needs to acquire the around-view image during the first time interval to determine whether the vehicle meets the at least one nearing event criterion.

The after event detection module 113 acquires the at least one after event criterion according to the traffic indication and/or the at least one target, and the after event detection module 113 acquires the at least one moving status information and the at least one GPS information (e.g., the at least one moving status information and the at least one GPS information of the first time interval and the second time interval) of the vehicle, and determines whether the at least one moving status information and the at least one GPS information of the vehicle meet the at least one after event criterion. When the after event criterion is met, the after event detection module 113 determines that a violation event has occurred. In some embodiments, in addition to the at least one moving status information and the at least one GPS information of the first time interval and the second time interval, the after event detection module 113 further needs to acquire the around-view image during the first time interval and/or the second time interval to determine whether the vehicle meets the at least one after event criterion (for example, to confirm whether the vehicle runs a red light shown in the around-view image between the first time interval and the second time interval).

In other embodiments, the nearing event warning module 112 or the after event detection module 113 can further acquire at least one vehicle-related information in addition to the at least one moving status information and the at least one GPS information to assist in determination, for example, obtaining a steering wheel angel and a steering wheel speed or information of a turn signal or a brake light from an on-board diagnostics (OBD or OBD-II).

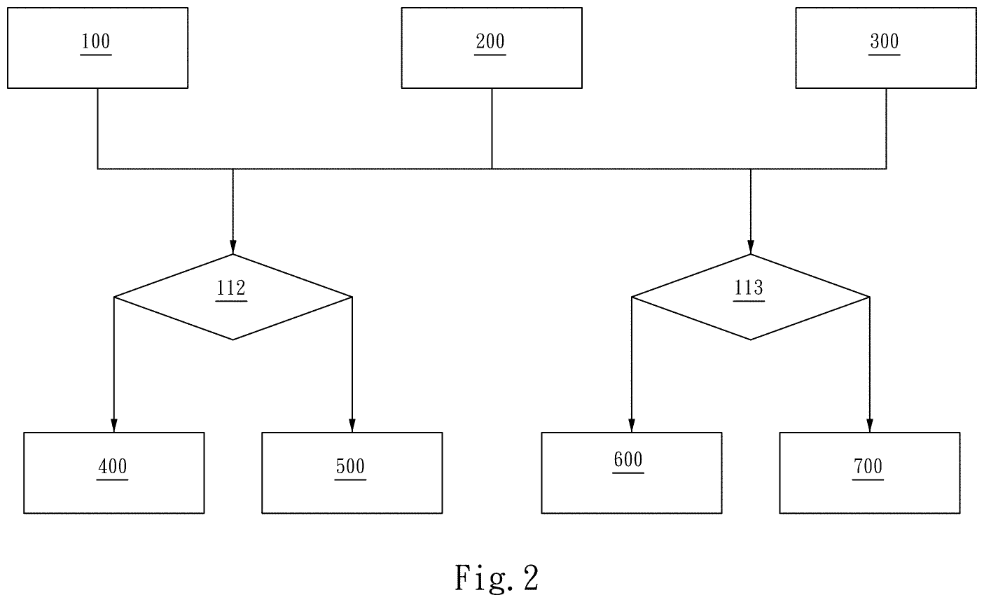

FIG. 2 illustrates a flowchart showing various steps of a method according to one embodiment of the invention, the nearing event warning module 112 determines whether the nearing event (blocks 400, 500) has occurred based on the traffic indication and/or the at least one target information (block 100), the at least one moving status information (block 200) and the at least one GPS information (block 300); the after event detection module 113 determines whether the violation event (blocks 600, 700) has occurred based on the traffic indication and/or the at least one target information (block 100), the at least one moving status information (block 200) and the at least one GPS information (block 300).

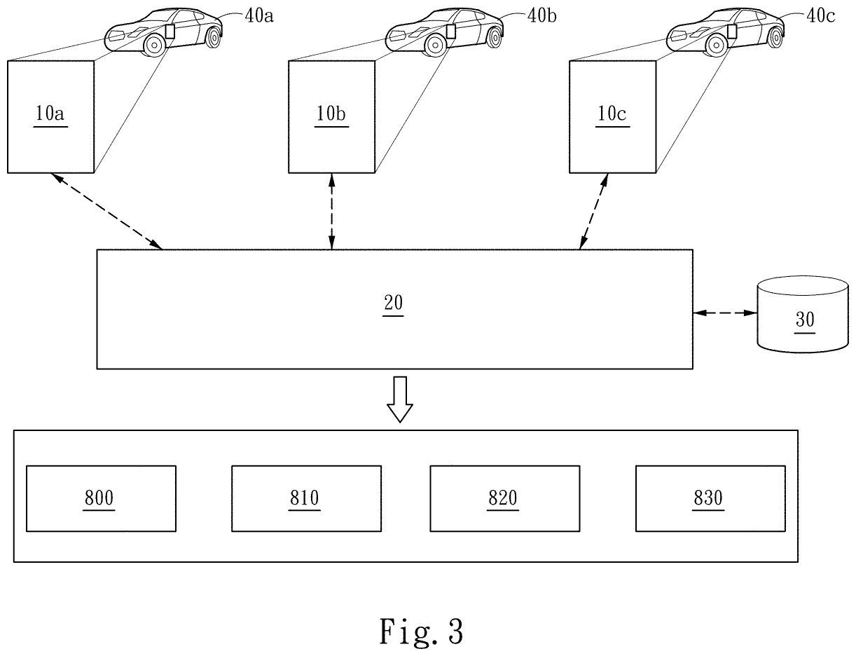

When the nearing event warning module 112 detects the nearing event and the after event detection module 113 detects the violation event, the nearing event warning module 112 and the after event detection module 113 respectively store the nearing event and the violation event in the memory unit 17 and/or transmit the nearing event and the violation event to the database 22 of the cloud device 20. FIG. 3 shows a fleet comprising a plurality of target vehicles 40a, 40b, 40c, each of the target vehicles 40a, 40b, 40c is respectively equipped with the edge device 10a, 10b, 10c, the edge devices 10a, 10b, 10c are communicatively connected to the cloud device 20 respectively, the cloud device 20 collects the nearing event and the violation event from the edge device 10a, 10b, 10c, and collects a driving record information related to the drivers from the external data source 30, the driving record information comprises a ticket record of the driver, including a number of times of ticket and a type of ticket of the driver. Alternatively, the driving record information may further comprise a record of traffic accidents of the driver, including a number of times of traffic accidents and a type of traffic accident. Accordingly, the driver behavior analysis module 211 is capable of analyzing a driving behavior of the driver according to a nearing event data 800, a violation event data 810, a ticket data 820, and a relevance 830 of the aforementioned data.

Further, the driver behavior analysis module 211 is capable of analyzing the driving behavior of the driver according to any one or more of following factors: 1. a number of times of the nearing event; 2. a type of the nearing event; 3. a number of times of the violation event; 4. a type of the violation event; 5. a number of times of the ticket; 6. a type of the ticket; 7. a relevance between the nearing event and the violation event; and 8. a relevance between the nearing event, the violation event and the ticket.

The driver score analysis module 212 determines an information of a safety level of the driver based on a result generated by the driver behavior analysis module 211. It can be understood that, the relevance can be determined according to the nearing event, the violation event and the ticket during a period. For example, if a driver A has triggered the nearing event before an intersection, but the violation event is not found after the nearing event (passing through the intersection), and the driver A did not receive the ticket; if a driver B has triggered the nearing event before an intersection, the violation event was found after the nearing event (passing through the intersection), then the driving behavior of the driver A is determined to be better than the driving behavior of the driver B, because the driver A takes measures such as decelerating a vehicle after receiving the nearing event alert.

The following is an example of statistics of various drivers in a fleet. No. 900, No. 903 are drivers of medium risk, No. 900 is better than No. 903 since No. 900 had responded to the nearing event alert; No. 901 is a high-risk driver; No. 902 is a low-risk driver; and No. 904 is a good driver

| | The | The | | | |
|---|---|---|---|---|---|
| | number | number | the relevance | | The |
| | of times of | of times of | absence | presence | number |
| | the nearing | the violation | of | of | of times of |
| drivers | event | event | response | response | the ticket |
| 900 | 4 | 0 | 0 | 4 | 0 |
| 901 | 6 | 4 | 4 | 2 | 2 |
| 902 | 2 | 0 | 0 | 0 | 0 |
| 903 | 3 | 2 | 2 | 1 | 1 |
| 904 | 0 | 0 | 0 | 0 | 0 |

The presence or absence of response mentioned above refers to whether the driver immediately corrects the driving action at that moment after receiving the nearing event alert in order to avoid triggering the violation event.

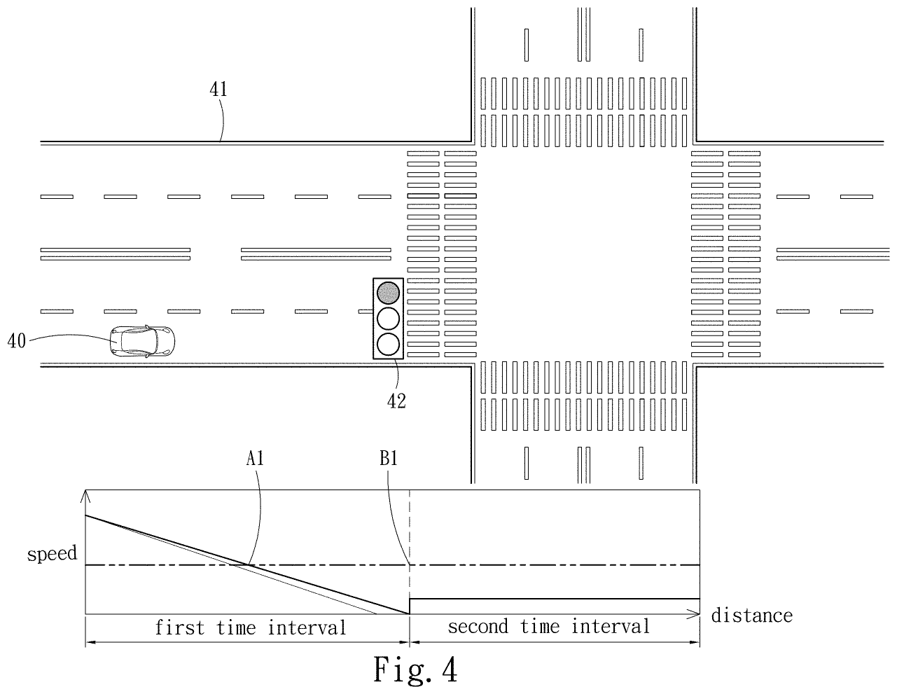

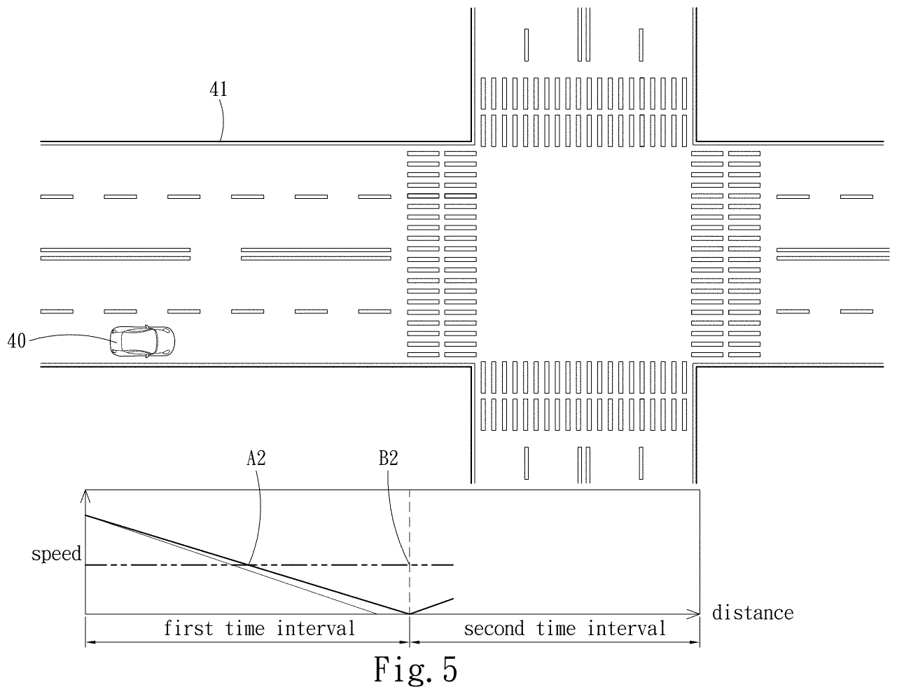

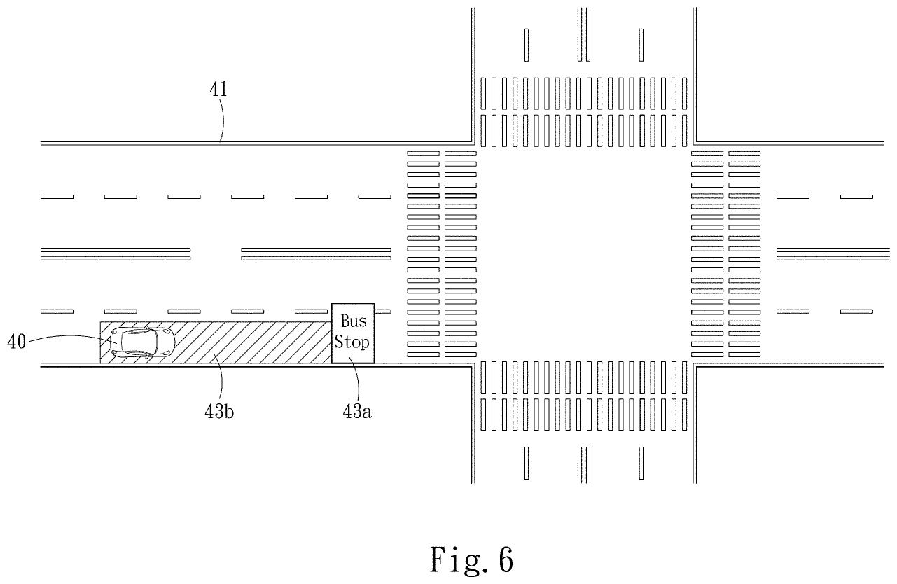

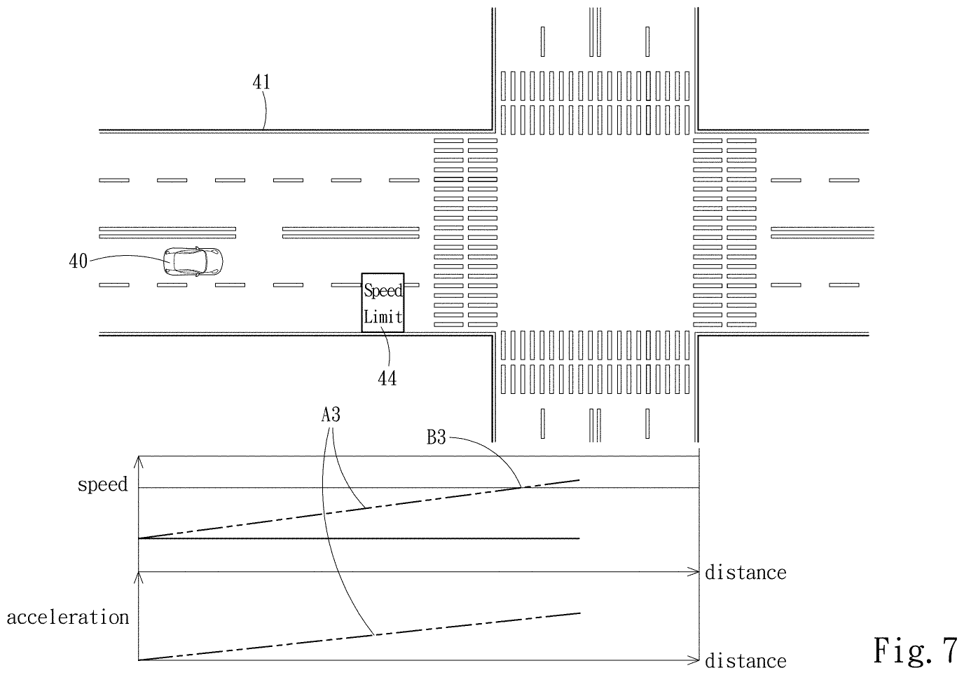

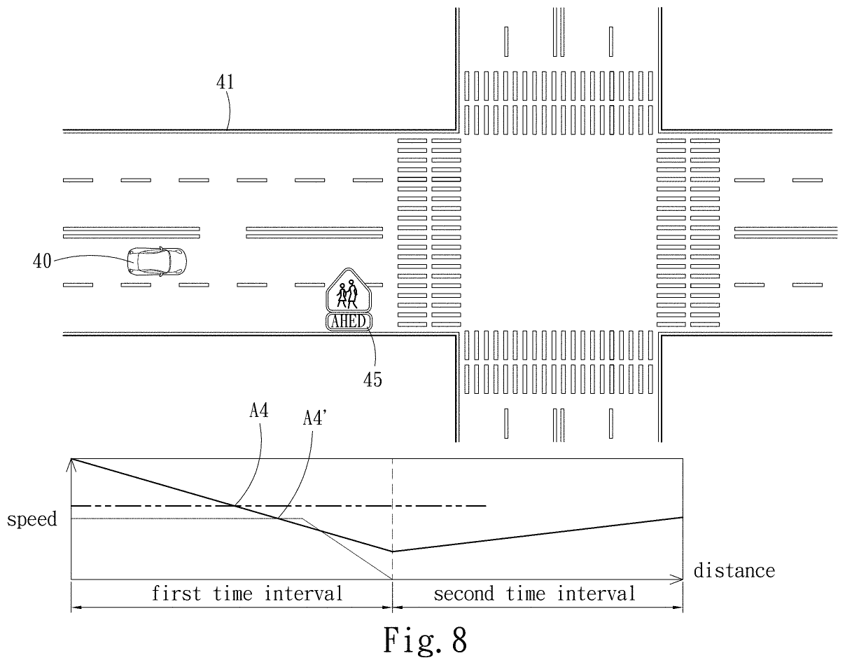

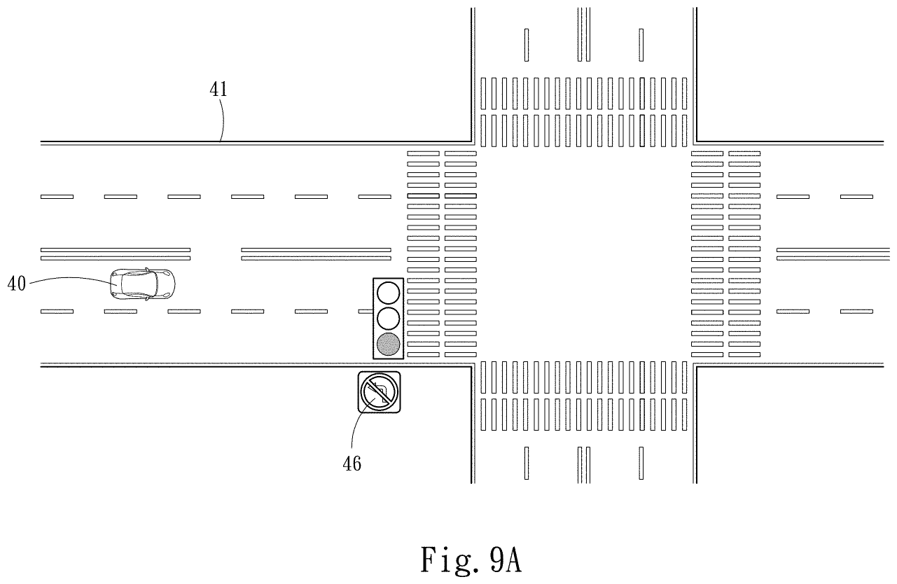

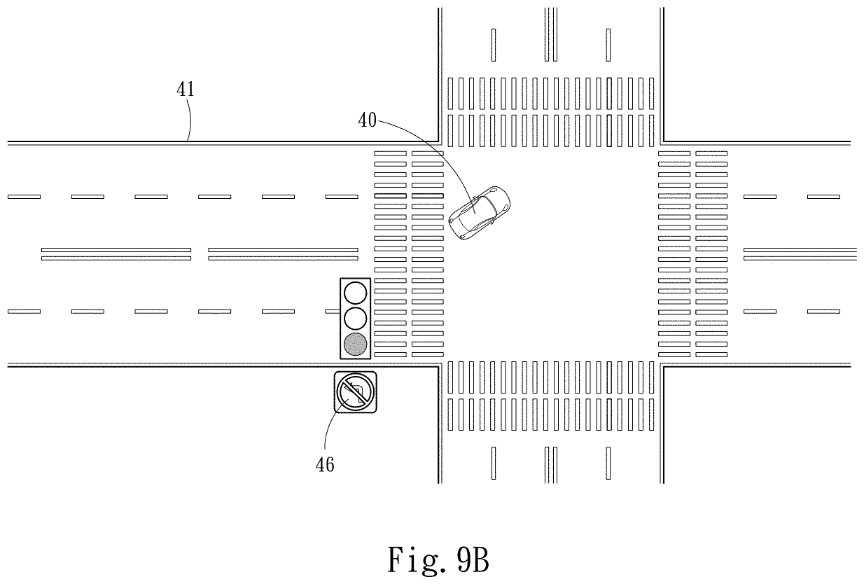

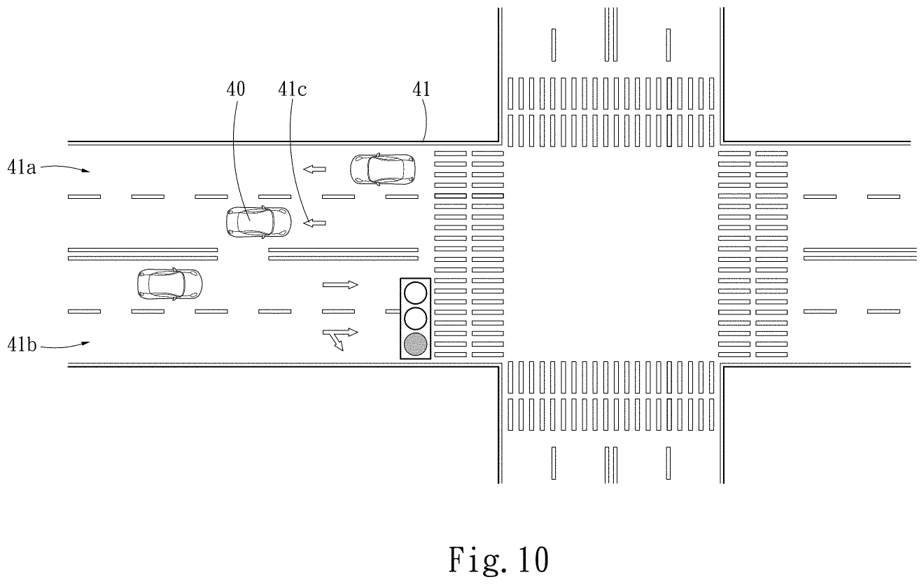

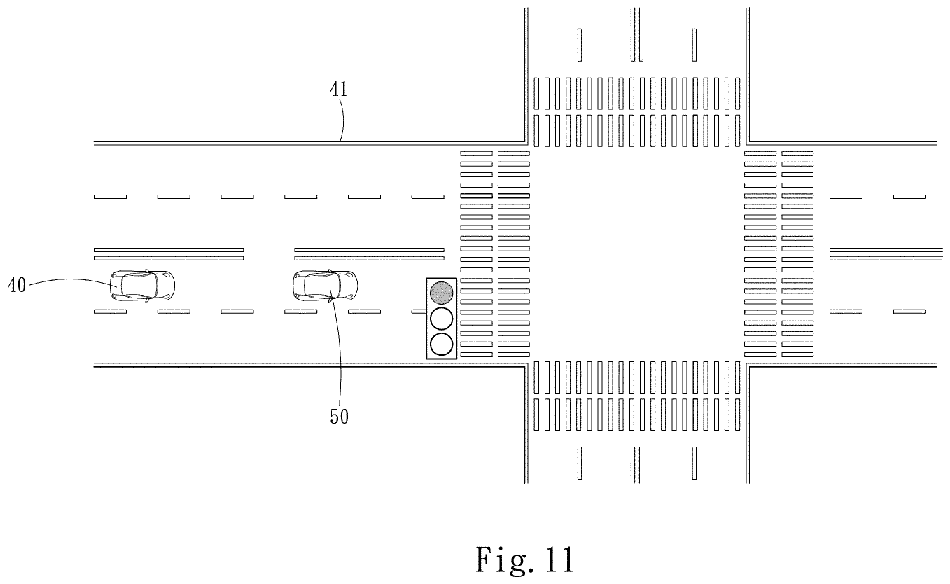

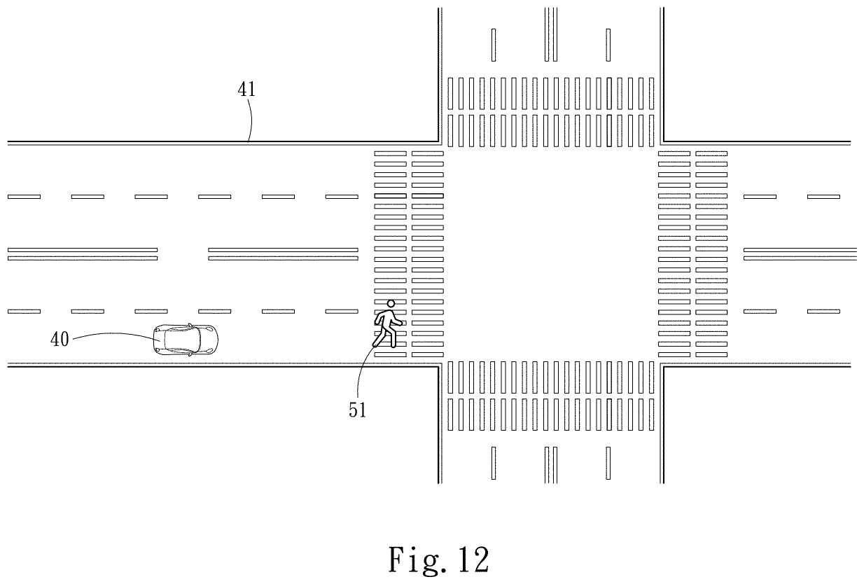

Several examples are given below to illustrate determination of the nearing event and the violation event. FIG. 4, FIG. 5, FIG. 6, FIG. 7, FIG. 8, FIG. 9A, FIG. 9B, FIG. 10, FIG. 11 and FIG. 12 show a target vehicle 40 driving on a road 41, and the lower parts in the diagrams show a relationship between a speed (and an acceleration) and a driving distance of the target vehicle 40. In these figures, the thick solid line represents a threshold of the at least one nearing event criterion and the at least one after event criterion, a dotted line represents the at least one nearing event criterion and the at least one after event criterion, and a thin solid line represents the at least one nearing event criterion and the at least one after event criterion are not met.

The traffic indication is exemplified as a traffic light:

In FIG. 4, when the traffic indication is a traffic light 42 displayed as a red light, and the target vehicle 40 is approaching the traffic light 42, if a speed (dotted line) of the target vehicle 40 is not decelerated below a threshold (thick solid line) before the target vehicle 40 arrives at the traffic light 42, the at least one nearing event criterion (point A1) is met; on the contrary, if a speed (thin solid line) of the target vehicle 40 is decelerated below the threshold (thick solid line), that is, the at least one nearing event criterion is not met.

When the traffic light 42 is still displayed as a red light, and the target vehicle 40 passes (crosses) the traffic light 42 (i.e., the dotted line is higher than the thick solid line), it is determined that the target vehicle 40 meets the at least one after event criterion (point B1); on the contrary, if the target vehicle 40 has not passed the traffic light 42, but has stopped before the traffic light 42, that is, the at least one after event criterion is not met.

The traffic indication is exemplified as a ground marking:

In FIG. 5, when the traffic indication is identified as an intersection without a traffic light according to a ground marking, and the target vehicle 40 is approaching the intersection, if a speed (dotted line) of the target vehicle 40 is not decelerated below a threshold (thick solid line) before the target vehicle 40 arrives at the intersection, the at least one nearing event criterion (point A2) is met; on the contrary, if a speed (thin solid line) of the target vehicle 40 is decelerated below the threshold (thick solid line), that is, the at least one nearing event criterion is not met.

If the target vehicle 40 passes (crosses) the intersection without decelerating, it is determined that the target vehicle 40 meets the at least one after event criterion (point B2); on the contrary, if the target vehicle 40 decelerates before passing (crossing) the intersection, that is, the at least one after event criterion is not met.

FIG. 6 shows that the road 41 is provided with a bus stop sign 43a and a bus stop area 43b. The area 43b can be identified from the around-view image that the traffic indication is the ground marking and is a road section where parking is prohibited, and the stop sign 43a can be identified from the around-view image that the traffic indication is the traffic sign and is a road section where parking is prohibited. A bus stop is used as an example here, but in other examples, red line, channelizing-line marking, or crosshatch marking can also be included. If an engine of the target vehicle 40 is turned on, and a time interval in which a position of the target vehicle 40 stopping in the area 43b is longer than a first stop threshold, the at least one nearing event criterion is met, or if the engine of the target vehicle 40 is turned off, the at least one nearing event criterion is also met; on the contrary, if the engine of the target vehicle 40 is turned on, and a time interval in which a position of the target vehicle 40 stopping in the area 43b is shorter than the first stop threshold, that is, the at least one nearing event criterion is not met.

If the target vehicle 40 is turned on, and a time interval in which a position of the target vehicle 40 continuously stopping in the area 43b is longer than a second stop threshold (greater than the first stop threshold), the at least one after event criterion is met, or if a time interval in which the engine of the target vehicle 40 is turn off exceeds the second stop threshold, the at least one after event criterion is also met; on the contrary, if a time interval in which a position of the target vehicle 40 stopping in the area 43b is between the first stop threshold and the second stop threshold, that is, the at least one nearing event criterion is met and the at least one after event criterion is not met.

The traffic indication is exemplified as the traffic sign:

In FIG. 7, the traffic indication is the traffic sign showing a speed limit (i.e., a speed limit sign 44), if a speed and an acceleration of the target vehicle 40 at that time point are respectively higher than a speed threshold (lower than a speed limit of the speed limit sign 44) and an acceleration threshold, the at least one nearing event criterion (point A3) is met; on the contrary, if a speed and an acceleration of the target vehicle 40 at that time point are respectively lower than the speed threshold (lower than a speed limit of the speed limit sign 44) and the acceleration threshold, that is, the at least one nearing event criterion is not met.

If a speed of the target vehicle 40 at that time point is higher than a speed limit of the speed limit sign 44, it is determined that the target vehicle 40 meets the at least one after event criterion (point B3); on the contrary, if a speed of the target vehicle 40 at that time point is lower than a speed limit of the speed limit sign 44, i.e., the at least one after event criterion is not met.

Referring to FIG. 8, or, for example, the target vehicle 40 is approaching a traffic sign 45 showing beware of pedestrians or beware of children, if a speed of the target vehicle 40 is not decelerated below a threshold before arriving at the traffic sign 45, then the at least one nearing event criterion (point A4) is met; on the contrary, if a speed of the target vehicle 40 is decelerated below the threshold, then the at least one nearing event criterion is not met. FIG. 8 also shows another situation, the thin solid line shows that the target vehicle 40 meets the at least one nearing event criterion at point A4′, the driver decelerates in time after receiving the nearing event alert, and stops the vehicle by braking before arriving at the traffic sign 45.

Examples in FIG. 9A and FIG. 9B illustrate that the traffic indication is a traffic sign 46 prohibiting left-turning. In FIG. 9A, the target vehicle 40 is approaching the traffic sign 46 (before reaching the traffic sign 46), if it is determined that the target vehicle 40 may be or is ready to make a left turn according to the at least one moving status information, the at least one GPS information and the on-board diagnostics of the vehicle 40, that is, it is determined that the at least one nearing event criterion is met; in FIG. 9B, after the target vehicle 40 has passed the traffic sign 46, if it is determined that the target vehicle 40 has turned left or is turning left according to the at least one moving status information, the at least one GPS information and the on-board diagnostics of the vehicle 40, that is, it is determined that the at least one after event criterion is met.

In an example of FIG. 10, a ground marking is identified from the around-view image, and lanes 41a, 41b and a driving direction 41c to be followed are identified according to the ground marking, if it is determined that the target vehicle 40 may be or is ready to drive in a wrong direction in the lane 41a according to the at least one moving status information and the at least one GPS information of the vehicle 40, that is, it is determined that the at least one nearing event criterion is met; if it is determined that the target vehicle 40 is already driving in a wrong direction in the lane 41a according to the at least one moving status information and the at least one GPS information of the vehicle 40, that is, it is determined that the at least one after event criterion is met.

The at least one target is exemplified as a vehicle:

FIG. 11 shows that there is a vehicle 50 around and in front of the target vehicle 40, FIG. 12 shows that there is a pedestrian 51 in front of the target vehicle 40, and the vehicle 50 and the pedestrian 51 are determined as the targets. It is determined whether the target vehicle 40 is driving on a possible collision route according to positions of the targets (the vehicle 50 and the pedestrian 51) in the around-view image, the at least one moving status information and the at least one GPS information of the vehicle 40, if so, the nearing event warning module 112 further determines whether the at least one moving status information and the at least one GPS information of the vehicle 40 meet the at least one nearing event criterion; if meeting the at least one nearing event criterion, it is determined that the target vehicle 40 collides with the target according to the at least one moving status information and/or the at least one GPS information of the target vehicle 40, then it is determined that the at least one after event criterion is met.

In the invention, the nearing event warning module is used to predict before collision, accident, incident or violation of traffic laws, traffic regulations or traffic signs occurs in order to identify dangerous driving behaviors before causing the event, and send out the nearing event alert and record accordingly. In this way, compared with the driving behavior analysis technologies of fleet vehicle in the prior art that only judge the violations that have occurred, the management system of the invention is capable of analyzing driving behaviors more comprehensively and objectively. In addition, when the nearing event is detected before the event occurs, the management system is capable of further tracking whether the driver has triggered the at least one after event criterion (that is, the violation event occurs) after occurrence of the nearing event, determining whether the driving behavior of the driver is corrected after the driver receiving the nearing event alert according to the relevance, analyzing the driver's mentality more deeply, and understanding the driving behavior of each driver in the fleet vehicle in detail. On the other hand, the invention uses the nearing event warning module to warn the driver before the event occurs, which is capable of greatly reducing and avoiding the occurrence of accidents and violations, thereby improving the safety of driving, which is beneficial to management of the fleet vehicle.

What is claimed is:

1. A fleet vehicle management system comprising:
an edge device disposed in a vehicle, and the edge device comprising a processing module, a nearing event warning module, an after event detection module, an image capturing module, a GPS module and a moving status module, the processing module being configured to acquire at least one around-view image and determine at least one traffic indication according to the around-view image; and
a cloud device communicatively connected to the edge device, the cloud device comprising a driver behavior analysis module and a database;
wherein the nearing event warning module acquires a nearing event criterion according to the traffic indication, the nearing event warning module acquires at least one moving status information of the vehicle in a first time interval from the moving status module, and acquires at least one GPS information of the vehicle in the first time interval from the GPS module to determine whether the vehicle meets the nearing event criterion, a nearing event is triggered when the nearing event criterion is met, the nearing event warning module sends out a nearing event alert to a driver of the vehicle via an output module disposed in the vehicle;
wherein the after event detection module acquires an after event criterion according to the traffic indication, the after event detection module acquires the at least one moving status information of the vehicle in the first time interval and the at least one moving status information of the vehicle in a second time interval from the moving status module, and acquires the at least one GPS information of the vehicle in the first time interval and at least one GPS information of the vehicle in the second time interval from the GPS module to determine whether the vehicle meets the after event criterion, and a violation event is triggered when the after event criterion is met; and
wherein the database is configured to store the nearing event alert, a driving violation result and a driving record information of the driver, and the driver behavior analysis module generates an information for evaluating a driving score of the driver based on the nearing event, the violation event and the driving record information.

2. The fleet vehicle management system as claimed in claim 1, wherein the traffic indication is at least any one of a traffic sign, a traffic light, a ground sign or a ground marking.

3. The fleet vehicle management system as claimed in claim 1, wherein the driver behavior analysis module generates the information for evaluating the driving score of the driver based on a relevance between the nearing event, the violation event and the driving record information.

4. The fleet vehicle management system as claimed in claim 1, wherein the driver behavior analysis module generates the information for evaluating the driving score of the driver according to a number of times of the nearing event, a number of times of the violation event, and a number of times of ticket of the driving record information.

5. The fleet vehicle management system as claimed in claim 1, wherein the nearing event alert is a visual alert, a sound alert, a haptic alert or any combination thereof.

6. The fleet vehicle management system as claimed in claim 1, wherein the first time interval is earlier than the second time interval, and the first time interval and the second time interval are consecutive to each other.

7. The fleet vehicle management system as claimed in claim 1, wherein the driving record information at least comprises a number of times of ticket and a type of ticket.

8. A fleet vehicle management system comprising:
an edge device disposed in a vehicle, and the edge device comprising a processing module, a nearing event warning module, an after event detection module, an image capturing module, a GPS module and a moving status module, the processing module being configured to acquire at least one around-view image and determine at least one target according to the around-view image; and
a cloud device communicatively connected to the edge device, the cloud device comprising a driver behavior analysis module and a database;
wherein the nearing event warning module acquires a nearing event criterion according to the at least one target, the nearing event warning module acquires at least one moving status information of the vehicle in a first time interval from the moving status module, and acquires at least one GPS information of the vehicle in the first time interval from the GPS module to determine whether the vehicle meets the nearing event criterion, a nearing event is triggered when the nearing event criterion is met, the nearing event warning module sends out a nearing event alert to a driver of the vehicle via an output module disposed in the vehicle;
wherein the after event detection module acquires an after event criterion according to the at least one target, the after event detection module acquires the at least one moving status information of the vehicle in the first time interval and the at least one moving status information of the vehicle in a second time interval from the moving status module, and acquires the at least one GPS information of the vehicle in the first time interval and at least one GPS information of the vehicle in the second time interval from the GPS module to determine whether the vehicle meets the after event criterion, and a violation event is triggered when the after event criterion is met; and
wherein the database is configured to store the nearing event alert, a driving violation result and a driving record information of the driver, and the driver behavior analysis module generates an information for evaluating a driving score of the driver based on the nearing event, the violation event and the driving record information.

9. The fleet vehicle management system as claimed in claim 8, wherein the at least one target is at least any one of a pedestrian, an animal, a land vehicle, a moving obstacle or a fixed obstacle.

10. The fleet vehicle management system as claimed in claim 8, wherein the driver behavior analysis module generates the information for evaluating the driving score of the driver based on a relevance between the nearing event, the violation event and the driving record information.

11. The fleet vehicle management system as claimed in claim 8, wherein the driver behavior analysis module generates an information for evaluating a safety level of the driver according to a number of times of the nearing event, a number of times of the violation event and a number of times of the ticket.

12. The fleet vehicle management system as claimed in claim 8, wherein the nearing event alert is a visual alert, a sound alert, a haptic alert or any combination thereof.

13. The fleet vehicle management system as claimed in claim 8, wherein the first time interval is earlier than the second time interval, and the first time interval and the second time interval are consecutive to each other.

14. The fleet vehicle management system as claimed in claim 8, wherein the driving record information at least comprises a number of times of ticket and a type of ticket.
